(19) United States
(12) Patent Application Publication
(10) Pub. No.: US 2012/0307365 A1
(43) Pub. Date: Dec. 6, 2012

(54) LENS BARREL ASSEMBLY

(75) Inventors: Bum Lee, Seongnam-si (KR); Won-jun Jeong, Anyang-si (KR)

(73) Assignee: Samsung Electronics Co., Ltd., Suwon-si (KR)

(21) Appl. No.: 13/294,384

(22) Filed: Nov. 11, 2011

(30) Foreign Application Priority Data
May 31, 2011 (KR) 10-2011-0052392

(51) Int. Cl. G02B 27/64; G02B 27/40; G02B 7/04

(52) U.S. Cl. 359/554; 359/823; 359/754; 359/738

(57) ABSTRACT

There is providing a lens barrel assembly including a base, a movable module movable along a linear path between a position close to the base and an extended position from the base, and a flexible printed circuit board including a first connection part, a bent part, and a second connection part. An end of the first connection part is connected to the movable module. The bent part is bent from the other end of the first connection part. An end of the second connection part is connected to the base and the other end of the second connection part is connected to the bent part. When the movable module is at a position close to the base, the first and second connection parts are close, and when the movable module is at the extended position, the first and second connection parts spread apart from the bent part.

### CROSS-REFERENCE TO RELATED PATENT APPLICATION

This application claims the priority benefit of Korean Patent Application No. 10-2011-0052392, filed on May 31, 2011, in the Korean Intellectual Property Office, the disclosure of which is incorporated herein in its entirety by reference.

### BACKGROUND

1. Field of the Invention

The invention relates to a lens barrel assembly, and more particularly, to a lens barrel assembly having a flexible printed circuit board disposed to reduce size, space, and number of components.

2. Description of the Related Art

Photographing apparatuses such as digital cameras may include lens barrel assemblies. Such a lens barrel assembly may be detachably attached to a photographing apparatus or may be permanently attached to a main body of a photographing apparatus in which an image pickup device is disposed. The lens barrel assembly may include an optical system for focusing, zooming, and light amount adjustment.

A main circuit board may be included in the lens barrel assembly to move the optical system, adjust the amount of light, or transmit on-off operation signals.

In general, the optical system is movably provided for focusing and zooming. A flexible printed circuit board is generally used to electrically connect the optical system and a main circuit board because the flexible printed circuit board is flexible, small, light, and three-dimensionally deformable.

However, due to the flexible printed circuit board, the size of the lens barrel assembly may increase, and additional components may be necessary to support the flexible printed circuit board, thus making it difficult to reduce the size of the lens barrel assembly and reduce the size of the lens barrel assembly.

### SUMMARY

The invention provides a compact lens barrel assembly in which a flexible printed circuit board is disposed to reduce the size, space and/or number of components of the lens barrel assembly.

According to an aspect of the invention, there is provided a lens barrel assembly including: a base; a movable module movable along a linear path between a position close to the base and an extended position spaced apart from the base; a flexible printed circuit board including a first connection part, a bent part, and a second connection part, wherein an end of the first connection part is connected to the movable module, the bent part is bent from the other end of the first connection part in opposite directions, and an end of the second connection part is connected to the base and the other end of the second connection part is connected to the bent part, wherein when the movable module is at a position close to the base, the first and second connection parts are close to each other, and when the movable module is at the extended position, the first and second connection parts spread apart from the bent part.

The bent part may be located in a space between the base and the movable module.

The first connection part may include: a first link part connected to the movable module; and a first extension part extending toward the bent part in a direction crossing a direction of the linear path of the movable module, wherein the second connection part may include: a second link part connected to the base; and a second extension part extending toward the bent part in a direction crossing the direction of the linear path of the movable module.

The movable module may include: a lens unit; and a support member supporting the lens unit.

The lens unit may include a plurality of lens groups.

The movable module may further include: a path change unit configured to change a path of at least a portion of light passing through the lens unit; and a driving unit configured to drive the path change unit.

The path change unit may be an aperture or shutter including an opening through which image light passes, wherein the aperture or the shutter may adjust an amount of image light by adjusting a size of the opening.

The path change unit may be an optical image stabilizer that is movable in a direction crossing a direction of the linear path of the movable module to compensate for hand shake.

The driving unit may be located at a front part of the support member, and the support member may include a hole through which the end of the first connection part is connected to the driving unit.

The end of the first connection part may be connected to the driving unit.

The base may include a main circuit board configured to process signals.

The end of the second connection part may be connected to the main circuit board.

The bent part may have a U-shape.

The bent part may have a W-shape.

The flexible printed circuit board may further include an elastic member encircling the bent part.

### BRIEF DESCRIPTION OF THE DRAWINGS

The above and other features and advantages of the invention will become more apparent by describing in detail exemplary embodiments thereof with reference to the attached drawings in which:

FIG. 1 is a partial sectional view illustrating a lens barrel assembly, according to an embodiment;

FIG. 2 is a partial sectional view illustrating an extended state of the lens barrel assembly of FIG. 1, according to an embodiment;

FIG. 3A is a schematic perspective view illustrating a flexible printed circuit board of the lens barrel assembly illustrated in FIG. 1, according to an embodiment;

FIG. 3B is a schematic perspective view illustrating a modification of the example flexible printed circuit board of the lens barrel assembly of FIG. 1, according to an embodiment;

FIG. 3C is a schematic perspective view illustrating the flexible printed circuit board of the lens barrel assembly of FIG. 2, according to an embodiment;

FIG. 3D is a schematic perspective view illustrating a modification of the example flexible printed circuit board of the lens barrel assembly illustrated in FIG. 2, according to an embodiment;

FIG. 4A is a partial block diagram illustrating the lens barrel assembly, according to an embodiment;

FIG. 4B is a partial block diagram illustrating a lens barrel assembly, according to another embodiment; and

FIG. 5 is a partial perspective view illustrating the lens barrel assembly of FIG. 1, according to an embodiment.

### DETAILED DESCRIPTION

Exemplary embodiments of the invention will be described below in detail with reference to the accompanying drawings. In the following description, incoming light is incident on the front side or object side of a lens barrel assembly. In addition, a movable module moves in an optical-axis direction (i.e., a Z-axis direction).

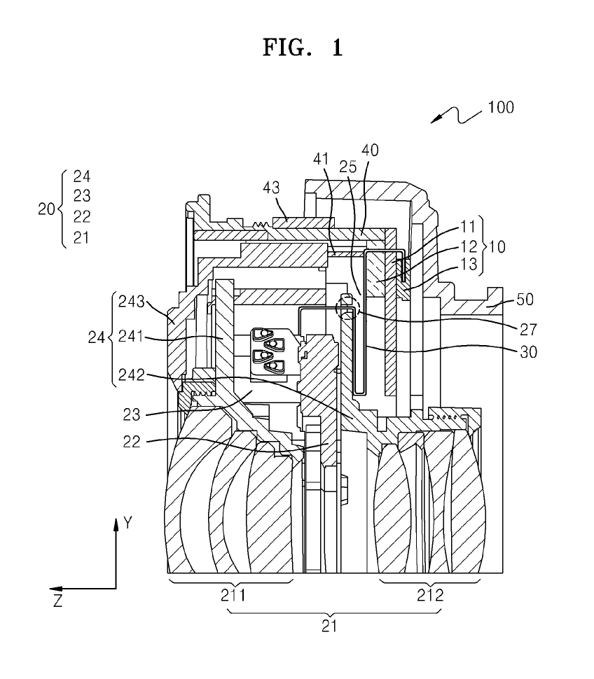

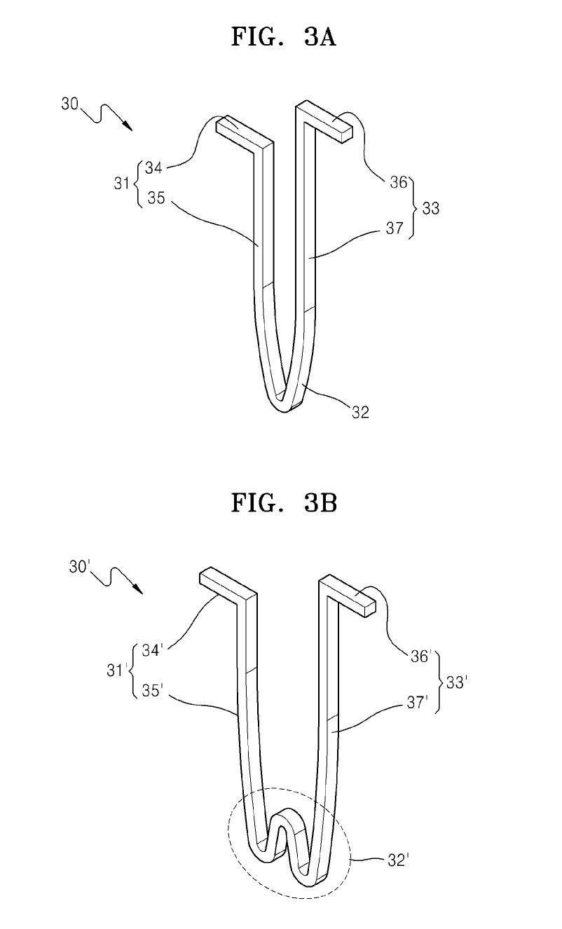

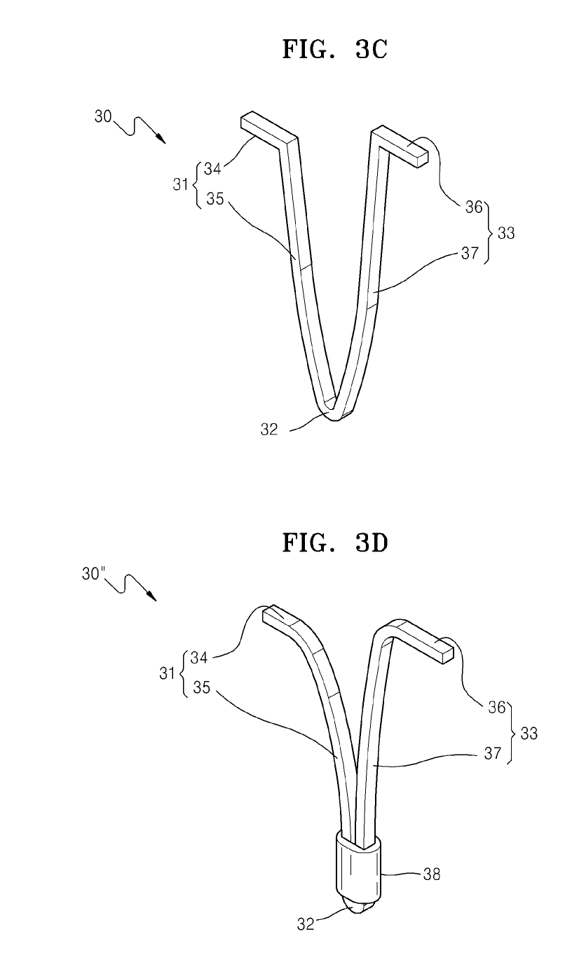

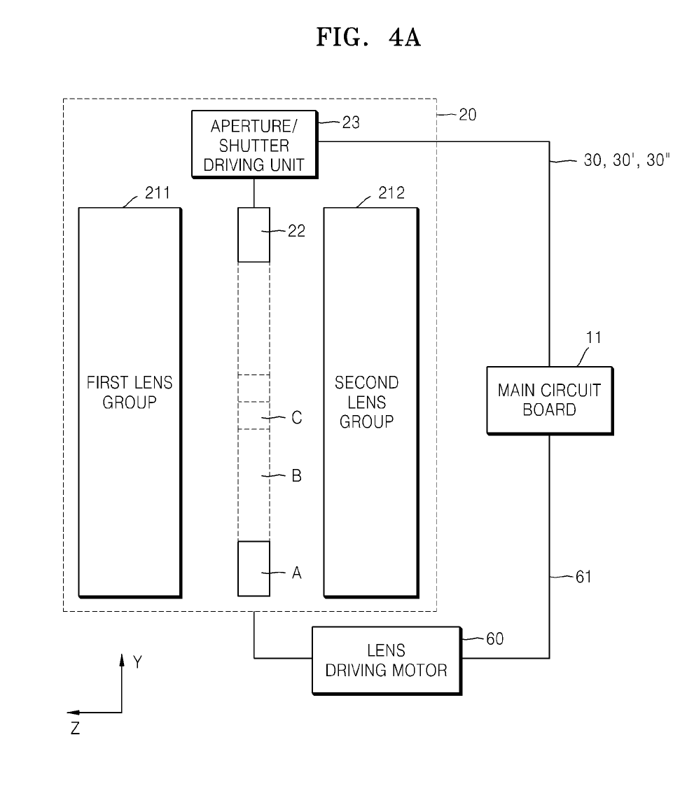

FIG. 1 is a partial sectional view illustrating a lens barrel assembly 100 according to an embodiment. FIG. 3A is a schematic perspective view illustrating a flexible printed circuit board 30 of the lens barrel assembly 100 illustrated in FIG. 1, according to an embodiment. FIG. 3B is a schematic perspective view illustrating a modified example 30′ of the flexible printed circuit board 30 of the lens barrel assembly 100 of FIG. 1, according to another embodiment.

Referring to FIG. 1, the lens barrel assembly 100 includes: a first lens group 211 located at the front side of the lens barrel assembly 100; a second lens group 212 located behind the first lens group 211; an aperture 22 located between the first lens group 211 and the second lens group 212; a driving unit 23 of the aperture 22; a main circuit board 11 located at a rear part of the second lens group 212 and included in a base 10 to process signals; and the flexible printed circuit board 30 connecting the driving unit 23 and the main circuit board 11.

The first lens group 211 is supported by a first lens barrel 241 including a plurality of grooves corresponding to a plurality of lenses of the first lens group 211, and a movable barrel 243 is located outside the first lens barrel 241 to hold the first lens barrel 241.

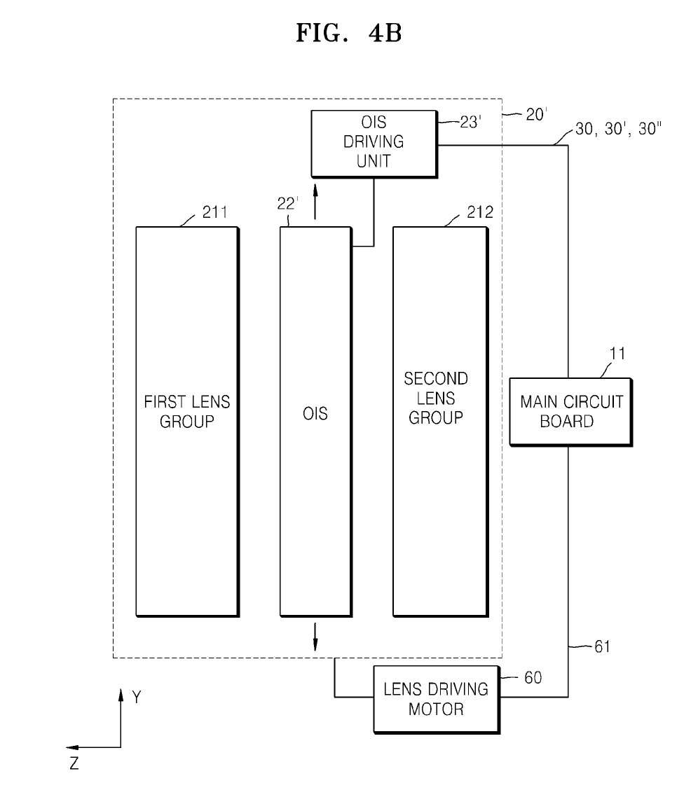

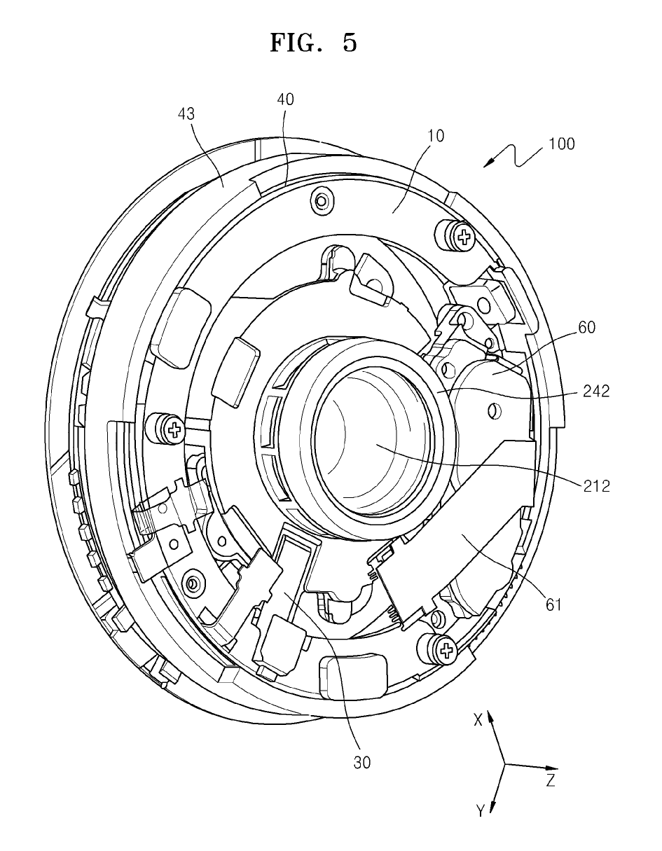

A cylindrical member 40 is located around the movable barrel 243, and a cam barrel 43 is located around the cylindrical member 40. The cylindrical member 40 includes a guide hole 41 extending in an optical axis direction so that the movable barrel 243 can be moved in the optical axis direction. The movable barrel 243 includes a protrusion (not shown) corresponding to the guide hole 41. The protrusion is inserted in the guide hole 41. The cam barrel 43 includes a guide groove (not shown) corresponding to the protrusion of the movable barrel 243 inserted in the guide hole 41 of the cylindrical member 40. The guide groove is formed in an inner side of the cam barrel 43. The protrusion of the movable barrel 243 is inserted in the guide groove of the cam barrel 43 and into the guide hole 41 of the cylindrical member 40. Therefore, the movable barrel 243 and the cam barrel 43 are connected to each other. The cam barrel 43 is connected to a lens driving motor 60 (refer to FIGS. 4A and 5) that controls movement of lenses.

The second lens group 212 is supported by a second lens barrel 242 including a plurality of grooves corresponding to a plurality of lenses of the second lens group 212. The second lens barrel 242 and the first lens barrel 241 are formed in one piece.

The first lens group 211 and the second lens group 212 are moveable in the optical axis direction (i.e., the Z-axis direction) for focus adjustment when light is incident on the first lens group 211. For example, according to information about the distance to an object measured by a distance detector, the lens driving motor 60 is operated to rotate the cam barrel 43. As the cam barrel 43 is rotated, the first lens group 211 and the second lens group 212 are moved in the optical axis direction (Z-axis direction). Therefore, the relative distance between a lens unit 21 and an image pickup device (not shown) can be adjusted for focusing. The lens driving motor 60 may be an auto focusing (AF) motor having an auto focusing function.

In the embodiment shown in FIG. 1, the lens unit 21 includes two lens groups, namely, the first and second lens groups 211 and 212, and has a focusing function. However, the invention is not limited thereto. For example, the lens unit 21 may include three or more lens groups and have a focusing function and a zooming function. In addition, a plurality of lens units 21 may be used, and the plurality of lens units 21 may be moved together or relative to each other.

The aperture 22 and the driving unit 23 may be located between the first lens group 211 and the second lens group 212.

The aperture 22 may be attached to the second lens barrel 242 using fasteners such as screws or an adhesive. The aperture 22 includes an opening so that image light that passes through the first lens group 211 can pass through the aperture 22. The size of the opening may be adjusted to block some of the image light to adjust the amount of the image light. For example, the aperture 22 may be a shutter. In this case, if the shutter is off, the opening is closed. If the shutter is on, the opening is opened. In other words, image light can be selectively received by turning on or off the shutter.

The driving unit 23 is additionally attached to the aperture 22 to adjust the amount of incident light according to design specifications.

An end of the driving unit 23 is attached to the aperture 22, and the other end of the driving unit 23 is attached to the first lens barrel 241. The aperture 22 is attached to the second lens barrel 242. Since the first lens barrel 241, the aperture 22, the driving unit 23, and the second lens barrel 242 are connected to each other, the aperture 22 and driving unit 23 move together with the first and second lens groups 211 and 212 when the first and second lens groups 211 and 212 are moved in the optical axis direction (Z-axis direction) for focusing and/or zooming.

A movable module 20 of the lens barrel assembly 100 includes the lens unit 21 that includes the first and second lens groups 211 and 212, a support member 24, the aperture 22, and the driving unit 23. The lens unit 21 includes the first lens group 211 and the second lens group 212. The support member 24 includes the first lens barrel 241, the second lens barrel 242, and the movable barrel 243.

The movable module 20 may include an optical image stabilizer (OIS) and a driving unit for the optical image stabilizer.

The main circuit board 11 calculates displacement values of optical systems such as the lens unit 21 and the aperture 22 of the lens barrel assembly 100 according to a signal detected using a device such as a sensor. Then, the main circuit board 11 controls operations of the driving unit 23 and the lens driving motor 60. For this, the driving unit 23 and the lens driving motor 60 may be electrically connected to the main circuit board 11.

The base 10 is located at a rear part of the lens barrel assembly 100. The base 10 includes the main circuit board 11 to process signals and a retainer 12 to hold the main circuit board 11 in position. The main circuit board 11 and the retainer 12 may be attached to each other using fasteners such as screws. Alternatively, the main circuit board 11 and the retainer 12 may be attached to each other by other methods. An end of the retainer 12 is connected to the cylindrical member 40. Therefore, as the movable module 20 moves in the guide hole 41 of the cylindrical member 40, the movable module 20 (including the aperture 22 and the driving unit 23) gets closer or further away from the base 10, which includes the main circuit board 11 and the retainer 12. In other words, the relative distance between the movable module 20 and the base 10 varies.

The driving unit 23 of the aperture 22 is positionally independent of the lens driving motor 60 of the movable module 20. The driving unit 23 of the aperture 22 may be located between the first and second lens groups 211 and 212. In this case, the driving unit 23 is spaced apart from the main circuit board 11. Therefore, the flexible printed circuit board 30 may be used to connect the driving unit 23 and the main circuit board 11 electrically and three-dimensionally.

Referring to FIG. 3A, the flexible printed circuit board 30 includes a first connection part 31, a bent part 32, and a second connection part 33. An end of the first connection part 31 is connected to the driving unit 23 of the aperture 22. The bent part 32 is bent from the other end of the first connection part 31 in opposite directions. An end of the second connection part 33 is connected to the main circuit board 11, and the other end of the second connection part 33 is connected to the bent part 32. The first connection part 31 includes a first link part 34 connected to the driving unit 23 and a first extension part 35 extending to the bent part 32. The second connection part 33 includes a second link part 36 connected to the main circuit board 11 and a second extension part 37 extending to the bent part 32.

The first link part 34 of the flexible printed circuit board 30 may be connected to the driving unit 23 by soldering, and the second link part 36 may be electrically connected to the main circuit board 11 by inserting the second link part 36 in a connector 13 of the main circuit board 11. However, the invention is not limited thereto.

Referring to FIG. 1, the first extension part 35, the bent part 32, and the second extension part 37 of the flexible printed circuit board 30 are located in a space 25 between the second lens barrel 242 and the base 10. The space 25 is located at the rear side of the second lens barrel 242 and the flexible printed circuit board 30 does not extend in a radial direction (Y-axis direction) of the lens barrel assembly 100. Therefore, the flexible printed circuit board 30 need not affect the radial size of the lens barrel assembly 100. In addition, since the flexible printed circuit board 30 is close to or in contact with the second lens barrel 242 and the space 25 between the second lens barrel 242 and the main circuit board 11 is inevitably formed due to other design considerations, the flexible printed circuit board 30 need not affect the length (size in the Z-axis direction) of the lens barrel assembly 100. Therefore, the lens barrel assembly 100 can be small and space-efficient owing to the flexible printed circuit board 30.

The second lens barrel 242 includes a hole 27 through which the first connection part 31 of the flexible printed circuit board 30 can be passed to connect the driving unit 23 located in front of the second lens barrel 242 to the main circuit board 11 located behind the second lens barrel 242. The hole 27 is formed as a passage for the flexible printed circuit board 30 and a support structure for the flexible printed circuit board 30.

When the lens barrel assembly 100 is closed, the first extension part 35 of the flexible printed circuit board 30 extends from the first link part 34 to the bent part 32 in a direction crossing the optical axis direction (Z-axis direction), and the second extension part 37 of the flexible printed circuit board 30 extends from the bent part 32 to the second link part 36 connected to the main circuit board 11 in the direction crossing the optical axis direction (Z-axis direction). Therefore, when the lens barrel assembly 100 is closed, the first extension part 35 and the second extension part 37 may be approximately parallel with each other and approximately perpendicular to the optical axis direction. In addition, when the lens barrel assembly 100 is closed, the first extension part 35 and the second extension part 37 are close to each other.

As shown in FIG. 3A, the bent part 32 may have a U-shape. However, the shape of the bent part 32 is not limited to the U-shape.

For example, referring to the modification example 30′ of the flexible printed circuit board 30 shown in FIG. 3B, the modification example 30′ includes a W-shaped bent part 32′.

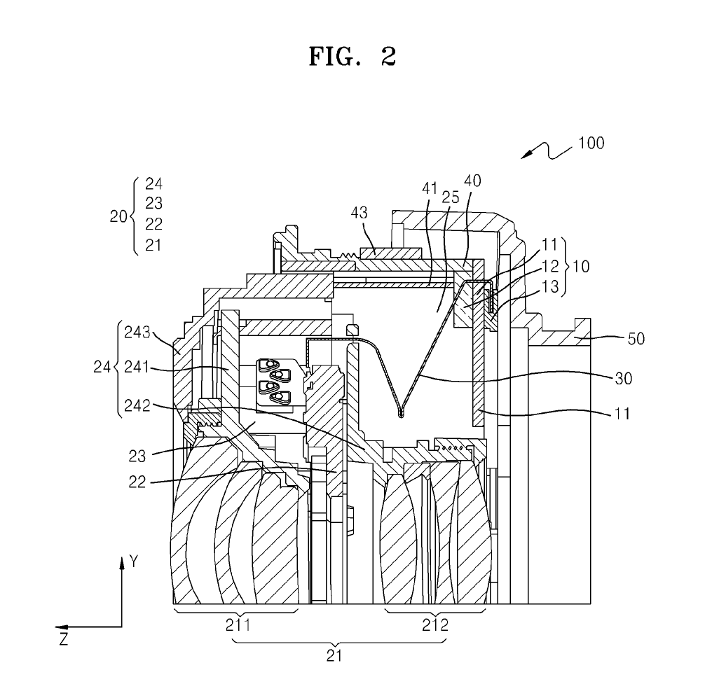

FIG. 2 is a partial sectional view illustrating an extended state of the lens barrel assembly 100 illustrated in FIG. 1, according to an embodiment. FIG. 3C is a schematic perspective view illustrating the flexible printed circuit board 30 illustrated in FIG. 2, according to an embodiment. FIG. 3D is a schematic perspective view illustrating another modification example of the flexible printed circuit board 30 illustrated in FIG. 2, according to another embodiment.

Referring to the lens barrel assembly 100 shown in FIG. 2, as the cam barrel 43 is rotated by the lens driving motor 60, the movable barrel 243 is moved in the guide hole 41 in the optical axis direction, and thus the first lens group 211, the second lens group 212, the first lens barrel 241, the second lens barrel 242, the aperture 22, and the driving unit 23 of the movable module 20 are moved together with the movable barrel 243 in the optical axis direction. In this way, the lens barrel assembly 100 (the movable module 20) is extended.

As the lens barrel assembly 100 is extended, the relative distance between the main circuit board 11 of the base 10 and the driving unit 23 connected to the aperture 22 is increased, and thus the flexible printed circuit board 30 is deformed.

Although the flexible printed circuit board 30 deforms and occupies more space when the lens barrel assembly 100 is extended, since the first extension part 35, the bent part 32, and the second extension part 37 of the flexible printed circuit board 30 are positioned in a space between the driving unit 23 and the main circuit board 11 that is increased as the lens barrel assembly 100 is extended, additional space is not necessary.

In addition, the flexible printed circuit board 30 is supported in the hole 27 of the second lens barrel 242, and the first extension part 35, the bent part 32, and the second extension part 37 can be freely positioned in the space between the driving unit 23 and the main circuit board 11. Thus, an additional component is not necessary for supporting the flexible printed circuit board 30.

Referring to FIG. 3C, the first extension part 35 and the second extension part 37 are formed in a V-shape. When the distance between the driving unit 23 and the main circuit board 11 is increased, the overall length of the flexible printed circuit board 30 is constantly maintained but the bent part 32 of the flexible printed circuit board 30 gets closer to an imaginary line drawn between the first link part 34 and the second link part 36.

Referring to FIG. 3D, the modification example of the flexible printed circuit board 30″ may further include an elastic member 38 enclosing the bent part 32.

The elastic member 38 encloses the bent part 32 so that the curvature of the bent part 32 is maintained when the movable module 20 is moved.

The elastic member 38 may be made of a resilient material such as resilient tape to prevent the flexible printed circuit board 30″ from being damaged by contact with the elastic member 38.

The elastic member 38 prevents the bent part 32 from fatigue fracture caused by frequent extending and retracting of the movable module 20. As a result, when the movable module 20 is extended, the first extension part 35 and the second extension part 37 may not be straightly kept but may be bent.

A mount 50 is located at the rearmost side of the lens barrel assembly 100. The lens barrel assembly 100 is connected to a main body (not shown) of a photographing apparatus (not shown) through the mount 50.

The main body may include: an image pickup device such as a charge-coupled device (CCD) or a complementary metal-oxide semiconductor (CMOS) device configured to receive image light passing through the lens unit 21 and convert the image light into an electric signal; a low pass filter (LPF) located in front of the image pickup device for removing noise; a signal processing unit configured to process signals; and an image display unit configured to display images and various image pickup conditions.

FIG. 4A is a partial block diagram illustrating the lens barrel assembly 100, according to an embodiment. FIG. 4B is a partial block diagram illustrating a lens barrel assembly, according to another embodiment.

Referring to FIG. 4A, the movable module 20 includes the first lens group 211, the second lens group 212, the aperture (or shutter) 22, and the driving unit 23 electrically connected to the aperture 22. Each of the first and second lens groups 211 and 212 may include a plurality of lens groups, each of which may include a plurality of lens.

The driving unit 23 operates the aperture 22 to adjust the size of the opening of the aperture 22 to control the amount of incident image light. In other words, the amount of incident image light is adjusted by blocking some of the incident image light using the aperture 22. If the aperture 22 is a shutter, all incident image light can be blocked by closing the opening using the shutter.

Referring to FIG. 4A, the opening of the aperture (or shutter) 22 can be adjusted between a wide state (A) and a narrow state (B). In addition, the opening of the aperture (or shutter) 22 can be adjusted to a completely closed state (C). Such an adjustment of the aperture (or shutter) 22 is carried out by the driving unit 23 that is connected to the main circuit board 11 through the flexible printed circuit board 30, 30′ or 30″. Since the driving unit 23 is included in the movable module 20, the relative distance between the driving unit 23 and the main circuit board 11 may vary as the movable module 20 is moved.

The lens driving motor 60 is connected to the outer side of the movable module 20 to move the movable module 20 in the optical axis direction. Like the driving unit 23, the lens driving motor 60 is connected to the main circuit board 11. However, the lens driving motor 60 is connected to the main circuit board 11 through another circuit board 61.

Referring to FIG. 4B, the lens barrel assembly of the other embodiment includes the same elements as those shown in FIG. 4A except that the lens barrel assembly includes an optical image stabilizer (OIS) 22′ instead of the aperture (or shutter) 22. A driving unit 23′ operates the OIS 22′.

The OIS 22′ moves on a plane perpendicular to an optical axis according to the amplitude and direction of vibration (hand shake) to compensate for the vibration.

Like the configuration shown in FIG. 4A, the driving unit 23′ is included in a movable module 20′ and is electrically connected to a main circuit board 11 through a flexible printed circuit board 30, 30′ or 30″. The flexible printed circuit board 30, 30′, 30″ may be the flexible printed circuit board in FIG. 3A, FIG. 3B or FIG. 3D.

FIG. 5 is a partial perspective view illustrating the lens barrel assembly 100 of FIG. 1, according to an embodiment.

Referring to FIG. 5, rear-side elements of the lens barrel assembly 100 are shown. The second lens group 212 and the second lens barrel 242 are located at a center region of the lens barrel assembly 100, and the lens driving motor 60 is located outside the second lens barrel 242. The cylindrical member 40 forms the outer side of the lens barrel assembly 100. The base 10 is connected to the cylindrical member 40. The base 10 is located along the circumference of the cylindrical member 40 in a manner such that the base 10 protrudes to the inside of the cylindrical member 40.

The cam barrel 43 is located outside the cylindrical member 40 and is connected to the lens driving motor 60. As the cam barrel 43 is rotated, the movable module 20 is moved in the optical axis direction.

The flexible printed circuit board 30 is located at the rear side of the second lens barrel 242. An end of the first link part 34 of the flexible printed circuit board 30 is connected to the driving unit 23. The first extension part 35 and the second extension part 37 of the flexible printed circuit board 30 are approximately parallel with a direction (Y-axis direction) perpendicular to the optical axis direction (Z-axis direction).

The lens barrel assembly 100 includes the circuit board 61 in addition to the flexible printed circuit board 30. The circuit board 61 is connected to the lens driving motor 60 that controls movement of the movable module 20. Although not shown in FIG. 5, the main circuit board 11 is included to the base 10. In addition, the main circuit board 11 is electrically connected to the second link part 36 of the flexible printed circuit board 30 and an end of the circuit board 61 electrically connected to the movable module 20.

As described above, according to the embodiments of the invention, a flexible printed circuit board is disposed to reduce size, space, and number of components of a lens barrel assembly, and to simplify the structure of the lens barrel assembly.

The apparatus described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, magnetic tapes, floppy disks, and optical data storage devices. The computer readable recording media may also be distributed over network coupled computer systems so that the computer readable code is stored and executed in a distributed fashion. This media can be read by the computer, stored in the memory, and executed by the processor.

Any references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. It will be recognized that the terms “comprising,” “including,” and “having,” as used herein, are specifically intended to be read as open-ended terms of art.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as” or “for example”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention.

What is claimed is:

1. A lens barrel assembly comprising:
a base;
a movable module movable along a linear path between a position close to the base and an extended position spaced apart from the base;
a flexible printed circuit board comprising a first connection part, a bent part, and a second connection part,
wherein an end of the first connection part is connected to the movable module, the bent part is bent from the other end of the first connection part in opposite directions, and an end of the second connection part is connected to the base and the other end of the second connection part is connected to the bent part,
wherein when the movable module is at a position close to the base, the first and second connection parts are close to each other, and when the movable module is at the extended position, the first and second connection parts spread apart from the bent part.

2. The lens barrel assembly of claim 1, wherein the bent part is located in a space between the base and the movable module.

3. The lens barrel assembly of claim 2, wherein the first connection part comprises:
a first link part connected to the movable module; and
a first extension part extending toward the bent part in a direction crossing a direction of the linear path of the movable module,
wherein the second connection part comprises:
a second link part connected to the base; and
a second extension part extending toward the bent part in a direction crossing the direction of the linear path of the movable module.

4. The lens barrel assembly of claim 1, wherein the movable module comprises:
a lens unit; and
a support member supporting the lens unit.

5. The lens barrel assembly of claim 4, wherein the lens unit comprises a plurality of lens groups.

6. The lens barrel assembly of claim 4, wherein the movable module further comprises:
a path change unit configured to change a path of at least a portion of light passing through the lens unit; and
a driving unit configured to drive the path change unit.

7. The lens barrel assembly of claim 6, wherein the end of the first connection part is connected to the driving unit.

8. The lens barrel assembly of claim 6, wherein the path change unit is an aperture or shutter comprising an opening through which image light passes, and
wherein the aperture or the shutter adjusts an amount of image light by adjusting a size of the opening.

9. The lens barrel assembly of claim 6, wherein the path change unit is an optical image stabilizer that is movable in a direction crossing a direction of the linear path of the movable module to compensate for hand shake.

10. The lens barrel assembly of claim 6, wherein the driving unit is located at a front part of the support member, and the support member comprises a hole through which the end of the first connection part is connected to the driving unit.

11. The lens barrel assembly of claim 1, wherein the base comprises a main circuit board configured to process signals.

12. The lens barrel assembly of claim 11, wherein the end of the second connection part is connected to the main circuit board.

13. The lens barrel assembly of claim 1, wherein the bent part has a U-shape.

14. The lens barrel assembly of claim 1, wherein the bent part has a W-shape.

15. The lens barrel assembly of claim 1, wherein the flexible printed circuit board further comprises an elastic member encircling the bent part.
